(19) United States
(12) Patent Application Publication
(10) Pub. No.: US 2010/0181775 A1
(43) Pub. Date: Jul. 22, 2010

(54) WIND POWER ELECTRICITY GENERATION SYSTEM

(76) Inventor: Qing-Lu YU, Taichung County (TW)

Correspondence Address: Ching-Ling Huang, 5597 NW 127th Ter, Portland, OR, 97229, US

(21) Appl. No.: 12/354,779

(22) Filed: Jan. 16, 2009

(51) Int. Cl. F03D 9/00

(52) U.S. Cl. 290/55

(57) ABSTRACT

A wind power electricity generation system includes a wind shade, a rack, a rotary means and a wind directing means. The rack is fixedly located in the wind shade. The rotary means is mounted on the rack and can rotate thereon. The wind directing means is fixedly mounted on the rack and located at the front end of the rotary means to channel wind direction and accelerate the wind and direct the wind to blow at an optimal angle to the rotary means. Therefore, a greater amount of wind power is generated to drive the rotary means and the starting wind power of the rotary means can be reduced. As a result, the rotary means can rotate in a small wind environment to function as an electric power generation source.

### FIELD OF THE INVENTION

The present invention relates to a wind power electricity generation system and particularly to a wind power electricity generation system which can reduce the starting wind power.

### BACKGROUND OF THE INVENTION

Wind power electricity generation is a most clean natural electricity regeneration source, thus is a widely endorsed eco-friendly power solution. References can be found in Taiwan patent application No. M296920 “Thermal wind power electricity generation system”, No. M307718 “Vehicle wind power electricity and light generation apparatus”, No. M326072 “DIY wind power electricity generation wall”, No. M329580 “Flow directing structure with reduced air resistance” and the like. They all try to generate electric power through the wind power. They produce no pollution and can be made at a lower cost, thus are widely accepted.

The aforesaid wind power electricity generation systems drive rotary blades to rotate through the kinetic energy of wind, then drive an electric generator to rotate and generate electric power. The wind has to reach a selected amount of power to rotate the blades, generally called starting wind power, to begin operation. As most wind power electricity generation systems are installed close to residence areas, the wind power generated in such environments cannot always be greater than the starting wind power for a long enough duration. Hence many wind power electricity generation systems cannot start as desired or can only generate very small amount of electricity. This seriously hinders applications and deployment of the wind power electricity generation.

### SUMMARY OF THE INVENTION

Therefore, the primary object of the present invention is to provide a wind power electricity generation system that is operable with low starting wind power to expand its deployments and applications.

To achieve the foregoing object, the wind power electricity generation system according to the invention includes a wind shade, a rack, a rotary means and a wind directing means. The wind shade has an air passage. The rack is fixedly located in the air passage of the wind shade. The rotary means has a plurality of rotary blades mounted on the rack in a radial manner and rotatable thereon. The wind directing means has a plurality of fixed vanes mounted on the rack in a radial manner and close to a front end of the rotary means.

By means of the structure set forth above, the wind directing means can channel airflow direction entering the air passage and accelerate wind speed and direct the wind at an optimal angle to rotate the rotary means. Hence the rotary means can be driven by a small wind and rotate. Namely the starting wind power is lower, and efficiency can increase and electricity generation amount produced through the wind power also is greater. Deployments and applications of the wind power electricity generation can also be expanded.

The foregoing, as well as additional objects, features and advantages of the invention will be more readily apparent from the following detailed description, which proceeds with reference to the embodiments below and accompanying drawings. The embodiments serve only for illustrative purpose and are not the limitations of the invention.

### BRIEF DESCRIPTION OF THE DRAWINGS

FIG. 1 is an exploded view of the invention.

FIG. 2 is a perspective view of the invention.

FIG. 3 is a fragmentary schematic view of the invention showing the flow path of directing wind.

FIG. 4 is an exploded view of another embodiment of the invention.

FIG. 5 is a perspective view of another embodiment of the invention.

### DETAILED DESCRIPTION OF THE PREFERRED EMBODIMENTS

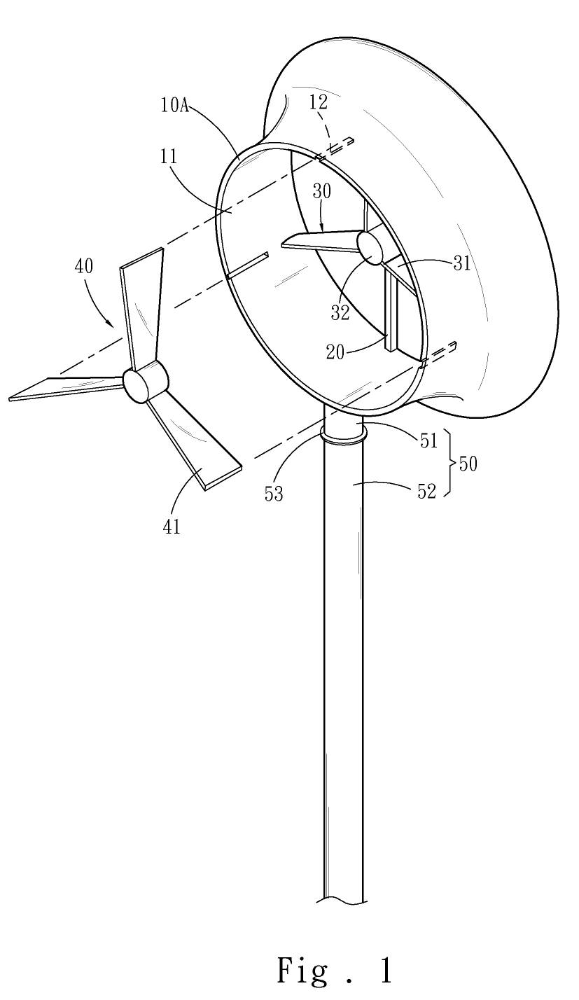

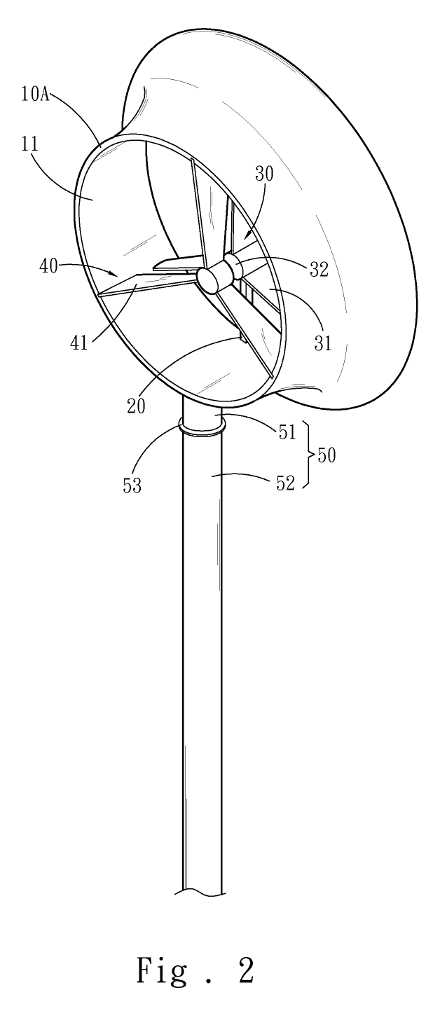

Please refer to FIGS. 1 and 2, the wind power electricity generation system according to the invention includes a wind shade 10A, a rack 20, a rotary means 30 and a wind directing means 40. The wind shade 10A has an air passage 11 and is mounted on an upright post 50. The upright post 50 includes a turnable portion 51 and a stationary portion 52 that are coupled together through a rotary bearing 53 so that the turnable portion 51 can turn about the stationary portion 52. The rack 20 is fixedly located in the air passage 11. The rotary means 30 has a plurality of radial rotary blades 31 and an axle 32 mounted on the rack 20 and rotatable thereon. The axle 32 also drives an electric generator (not shown in the drawings).

The wind directing means 40 has a plurality of fixed vanes 41 formed in a radial manner and close to a front end of the rotary means 30. The wind shade 10A has a latch trough 12 to be wedged in by the fixed vanes 41 for anchoring. The rotary blades 31 and fixed vanes 41 are preferably formed in three pieces respectively.

The rotary blades 31 may be formed with a selected twisting curvature while the fixed vanes 41 are formed with another twisting curvature inverse to the rotary blades 31 to allow wind to be channeled at an optimal angle to the rotary means 30. The rotary blades 31 may also be formed in an area gradually shrunk outwards from the rotation center, while the fixed vanes 41 are formed in another area gradually enlarged outwards from the center. The rotary blades 31 and fixed vanes 41 also have a thicker aweather wind surface than the lee wind surface to reduce wind resistance and expand wind receiving area to enhance efficiency. The air passage 11 may be extended rearwards to form a conical shape behind the rotary means 30 so that it has an outlet larger than an inlet to reduce the back pressure of the wind passing through the air passage 11.

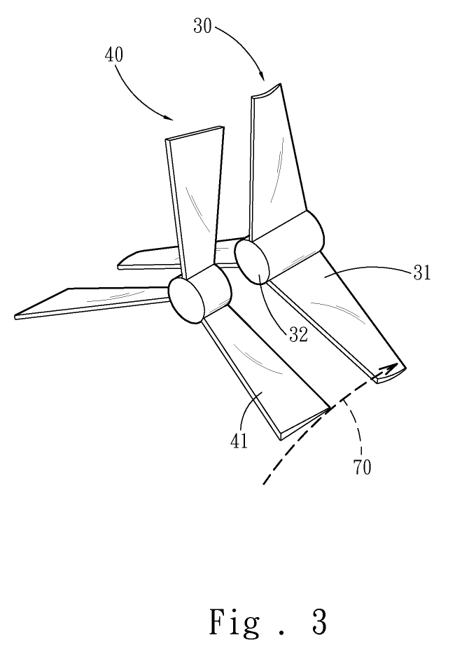

Referring to FIG. 3, the wind directing means 40 channels the wind passing through the air passage 11 in an airflow direction 70 (shown by a broken line in the drawing) so that the wind accelerates and blows the rotary means 30 at the optimal angle and drives it rotating. Therefore, even with input of a small wind, the rotary means 30 can still be driven and rotate. Thus the invention provides a very low starting wind power and can be widely deployed in various environments to supply steady and consistent electric power. Moreover, the wind directing means 40 can adjust wind pressure in a strong wind condition to prevent generation of shearing forces from the wind that might cause damage to the rotary means 30.

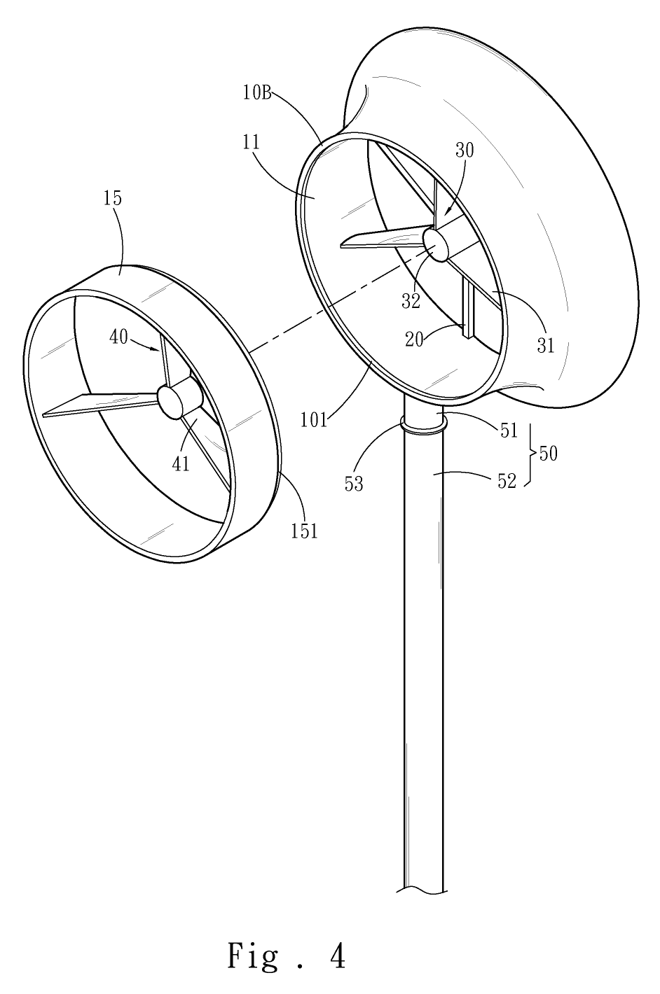

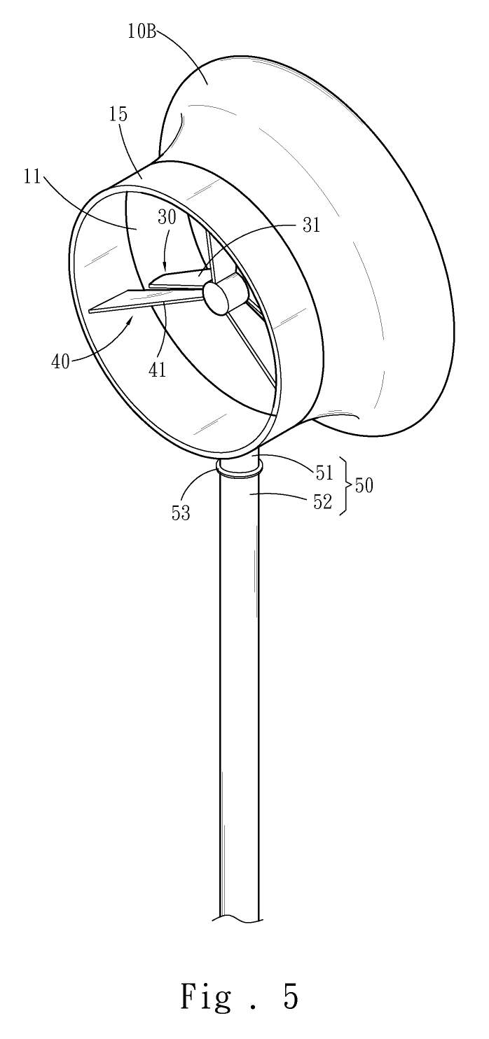

Referring to FIGS. 4 and 5, the wind shade 10B may also be fastened to a wind directing hood 15 at the front end. And the wind directing means 40 may be installed on the wind directing hood 15. The wind shade 10B and wind directing hood 15 have respectively a latch structure 101 and 151 that are engageable with each other for fastening. Then the wind directing means 40 can be installed on the front end of the rotary means 30.

As a conclusion, the present invention provides the wind directing means 40 to channel the airflow direction 70 of the wind so that the wind accelerates and blows the rotary means 30 at the optimal angle to rotate. Therefore, the starting wind power can be reduced and efficiency improves, and electric power generated through the wind increases. Thus applications of wind power electricity generation can be greatly expanded.

What is claimed is:

1. A wind power electricity generation system, comprising:
a wind shade having an air passage;
a rack fixedly located in the air passage;
a rotary means having a plurality of radial rotary blades mounted on the rack and rotatable; and
a wind directing means which has a plurality of radial fixed vanes mounted closely to a front end of the rotary means; the fixed vanes being fastened to the wind shade to channel wind direction entering the air passage and accelerate the wind speed and direct the wind to blow the rotary means at an optimal angle to drive the rotary means to rotate.

2. The wind power electricity generation system of claim 1, wherein the rotary blades of the rotary means are formed at a selected twisting curvature and the fixed vanes of the wind directing means are formed at another twisting curvature inverse to that of the rotary blades.

3. The wind power electricity generation system of claim 2, wherein the rotary blades are formed in an area gradually shrunk outwards from the rotation center thereof and the fixed vanes are formed in another area gradually enlarged outwards from the center thereof.

4. The wind power electricity generation system of claim 3, wherein the rotary blades and the fixed vanes have a greater thickness on an aweather wind surface than on a lee wind surface.

5. The wind power electricity generation system of claim 1, wherein the wind shade has a latch trough wedged in by each of the fixed vanes to form anchoring therewith.

6. The wind power electricity generation system of claim 1, wherein the air passage is extended from a rear end of the rotary means and formed in a conical shape so that the air passage has an outlet larger than an inlet thereof.

7. The wind power electricity generation system of claim 1, wherein the rotary means has an axle located on the rack and rotating thereon.

8. The wind power electricity generation system of claim 1, wherein the wind shade is mounted on an upright post.

9. The wind power electricity generation system of claim 8, wherein the upright post has a turnable portion and a stationary portion that are coupled together through a bearing.

10. The wind power electricity generation system of claim 1, wherein the rotary blades and the fixed vanes have respectively three pieces.

11. The wind power electricity generation system of claim 1 further having a wind directing hood fastened to a front end of the wind shade and the wind directing means is fixedly located on the wind directing hood.

12. The wind power electricity generation system of claim 11, wherein the wind shade and the wind directing hood have respectively a latch structure engageable with each other for fastening together.
